(19) United States
(12) Patent Application Publication
(10) Pub. No.: US 2016/0325865 A1
(43) Pub. Date: Nov. 10, 2016

(54) Bagging Assembly and Method

(71) Applicant: James R. O'Donnell, Spring, TX (US)

(72) Inventor: James R. O'Donnell, Spring, TX (US)

(21) Appl. No.: 15/143,292

(22) Filed: Apr. 29, 2016

Related U.S. Application Data
(60) Provisional application No. 62/159,105, filed on May 8, 2015.

(51) Int. Cl. B65B 39/06; F16M 11/22; B65F 1/14; B65B 67/12

(52) U.S. Cl. CPC B65B 39/06; B65B 67/1238; F16M 11/22; B65F 1/1415

(57) ABSTRACT

The application is directed to a bagging assembly operationally configured to hold a bag or the like in an open position in order to fill the bag with one or more items and/or materials and/or substances. The bagging assembly includes a base member and an inlet member to be placed atop the base member. The base member and inlet member are operationally configured to hold an open end of a bag or the like in an open position.

### CROSS-REFERENCE TO RELATED APPLICATIONS

This application claims the benefit of and priority to the following U.S. Provisional Patent Application No. 62/159,105 filed May 8, 2015, which is incorporated herein by reference in its entirety.

### STATEMENT REGARDING FEDERALLY SPONSORED RESEARCH OR DEVELOPMENT

Not applicable.

### FIELD OF THE INVENTION

This application relates generally to implementations concerning the directing of one or more items and/or materials and/or substances into a bag or similar item.

### BACKGROUND OF THE INVENTION

Persons often gather waste such as leaves, weeds, lawn clippings, branches, and other plant matter for disposal in garbage bags, e.g., 20-45 gallon plastic bags. Difficulty is often encountered when filling such bags during yard work and the like. For example, plastic garbage bags and the like are not rigid, and thus the open end of the bag is difficult to hold and keep open when trying to fill the bag with one or more items and/or materials and/or substances (collectively referred to hereafter as “storables”). Hands free devices for filling bags with storables are known. However, such devices use clips and other fasteners for holding a bag open. Other devices do not hold or secure enough of a bag to ensure that the bag stays in a fixed open position as the bag is being filled, i.e., as the bag is being weighted down when filled with storables. It is desirable to overcome such disadvantages.

### SUMMARY OF THE INVENTION

The present invention is directed to a bagging assembly, including (1) a base member having a first mating member and a plurality of support members operationally configured to maintain the first mating member apart from a support surface of the bagging assembly, the first mating member having an inner surface defining an opening there through; and (2) an inlet member operationally configured to releasably mate with the base member in a manner effective to maintain an open end of a bag between the inner surface of the first mating member and the inlet member in an open position for directing storables into the bag via the inlet member.

The present invention is also directed to a bagging assembly for holding a bag in an open position including (1) a base member including a cylindrical first mating member and a plurality of support members operationally configured to maintain the first mating member apart from a support surface of the bagging assembly; and (2) an inlet member having a conical shape member forming an inlet end and a cylindrical shape member forming an outlet end of the inlet member, the cylindrical shape member being operationally configured to releasably mate with the first mating member, the outer diameter of the cylindrical shape member being less than the inner diameter of the first mating member.

The present invention is also directed to a method of maintaining a bag in an open position for filling purposes, including (1) providing a bagging assembly including (a) a base member having a first mating member and a plurality of support members operationally configured to maintain the first mating member apart from a support surface of the bagging assembly, the first mating member having an inner surface defining an opening there through; and (b) an inlet member operationally configured to releasably mate with the base member in a manner effective to maintain an open end of a bag between the inner surface of the first mating member and the inlet member in an open position for directing storables into the bag via the inlet member; (2) placing the base member upon a support surface in an upright position; (3) inserting a bag through the opening of the first mating member and contacting an open end of the bag against the inner surface of the first mating member; and (4) placing the inlet member atop the base member in a manner effective to sandwich the bag there between.

### BRIEF DESCRIPTION OF THE SEVERAL VIEWS OF THE DRAWINGS

FIG. 1 is an exploded side view of an embodiment of a bagging assembly of the present application including a three legged base member.

FIG. 2 is a top view of an embodiment of a four legged base member of the bagging assembly of FIG. 1.

FIG. 3 is a side view of the bagging assembly of FIG. 1 in a mated position.

FIG. 4 is an exploded side view of another embodiment of a bagging assembly of the present application.

FIG. 5 is a top view of an embodiment of an exemplary base member of the bagging assembly of FIG. 4.

FIG. 6 is a side view of the bagging assembly of FIG. 4 in a mated position.

FIG. 7 is a top view of another embodiment of a base member of a bagging assembly of the present application.

FIG. 8 is a top view of another embodiment of a base member of a bagging assembly of the present application.

FIG. 9 is a top view of another embodiment of a base member of a bagging assembly of the present application.

FIG. 10 is a perspective phantom view of an exemplary inlet member of the bagging assembly of FIG. 4.

FIG. 11 is a side view of the bagging assembly of FIG. 4 including a flexible bag held open by the bagging assembly for filling purposes.

FIG. 12 is a side view of the bagging assembly of FIG. 1 including a flexible bag held open by the bagging assembly for filling purposes.

FIG. 13 is side view of an embodiment of a base member of a bagging assembly of the present application.

FIG. 14 is a top view of another embodiment of a base member of the present application.

FIG. 15 is a side view of the front of an exemplary support of a base member of the present application.

FIG. 16 is a view of the side of the support of FIG. 15.

FIG. 17 is an elevational view of the inner surface of the support of FIG. 15.

FIG. 18 is a top view of another exemplary support of a base member of the present application.

FIG. 19 is a side elevational view of an embodiment of an inlet member of a bagging assembly of the present application.

FIG. 20 is a top view of the inlet member of FIG. 19.

FIG. 21 is a side elevational view of a base member of a bagging assembly of the present application.

FIG. 22 is a top view of a first mating member of the base member of FIG. 21.

### DETAILED DESCRIPTION

Before describing the invention in detail, it is to be understood that the present assembly and method are not limited to particular embodiments. It is also to be understood that the terminology used herein is for the purpose of describing particular embodiments only, and is not intended to be limiting. As used in this specification and the appended claims, the term “bag” may include collection devices defined by an open end and a closed end including, but not necessarily limited to plastic garbage bags, plastic biohazard bags, sandbags, paper bags, and cloth bags including, but not necessarily limited to cotton bags, canvas bags, burlap bags, and nylon bags. Because Applicant, like the skilled artisan, recognizes that other materials may be developed and/or used in the future to produce bags, such materials are herein contemplated. The phrase “support surface” refers to the ground, or earth, or any other surface supporting the bagging assembly 10 during operation, e.g., floors, decks, porches, driveways, sidewalks, streets, parking lots, roof tops, and the like.

In one aspect, the application provides a bagging assembly for filling a bag without the necessity of fasteners, clips, tape, and the like to maintain the bag in an open position when filling the bag with storables.

In another aspect, the application provides a bagging assembly that may be hung on a wall, post or other support for storage purposes when not in use.

In another aspect, the application provides a bagging assembly that makes use of gravity for purposes of holding a target bag in an open position so that storables may be directed into the bag.

In another aspect, the application provides a bagging assembly operationally configured to sandwich the perimeter of an open end of a bag in a manner effective to hold the open end of the bag apart from the support surface of the bagging assembly in a substantially fixed position.

In another aspect, the application provides an inlet member including one or more projections operationally configured to extend into an open bag a desired distance during operation of the bagging assembly.

In another aspect, the application provides a bagging assembly operationally configured to receive lawn clippings in a vertical position from more than one type of lawn mower bagging unit. As persons of ordinary skill in the art understand, commercial lawn mower bagging units come in various shapes and sizes. As such, where two or more individuals are collectively mowing grass of a particular area but using different make/model lawn mowers with different shape and size bagging units, the bagging assembly of this application is operationally configured to receive lawn clippings in a vertical position from each of the bagging units in use. A sampling of various types of bagging units commercially available at the time of this application are commercially available from manufacturers including, but not necessarily limited to Honda Motor Company, Ltd., Toro, Deere & Company, Alpina, Lawn Boy, Cub Cadet, Ariens, Bolens, Brute, Craftsman, Husqvarna, MTD, Murray, Poulan Pro, Troy-Bilt, and Yard Machines.

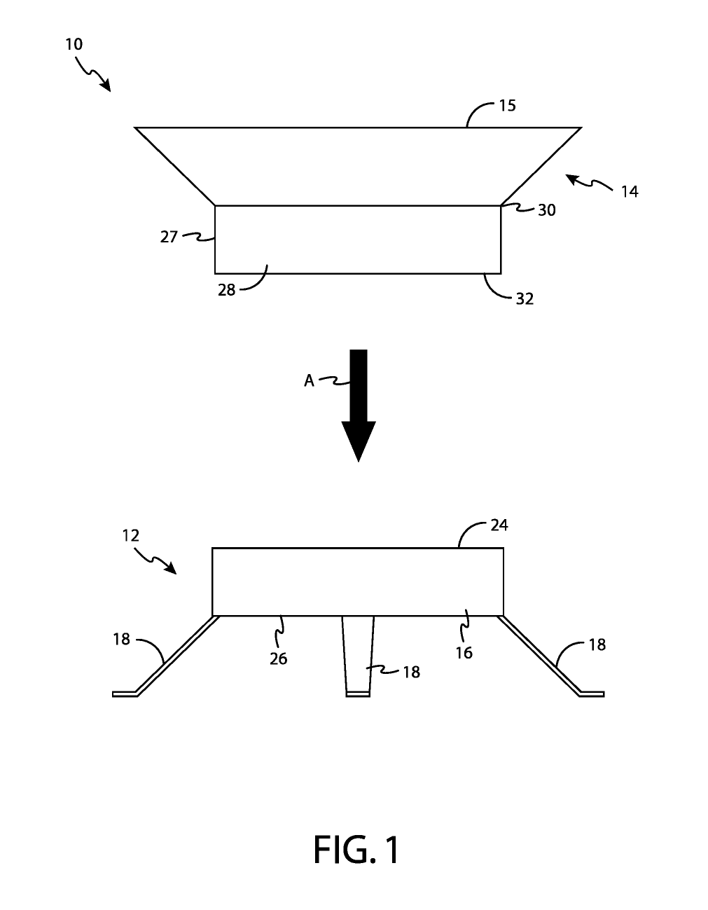

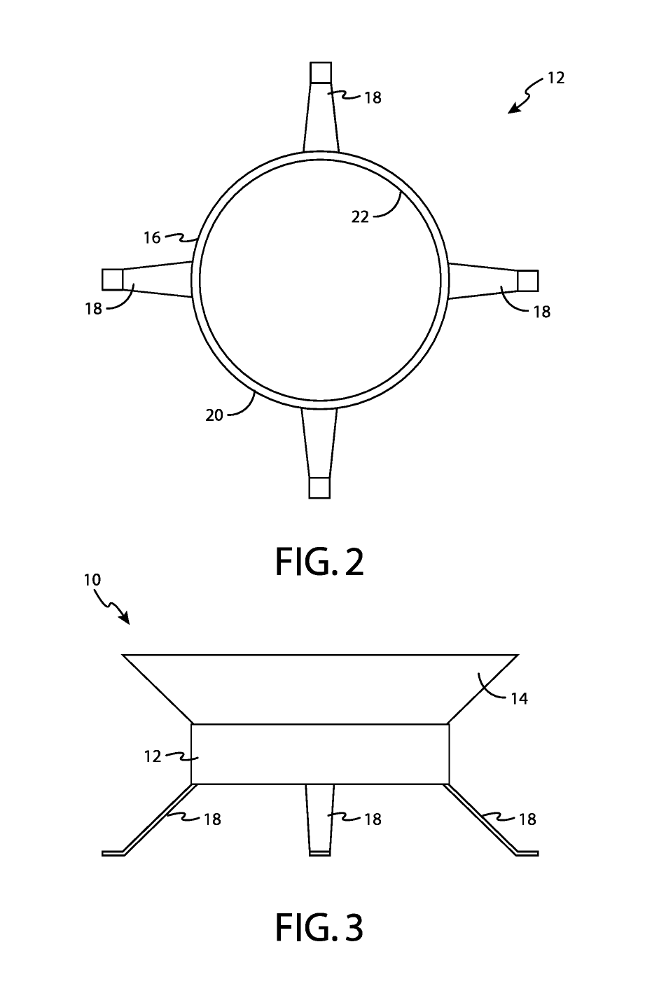

To better understand the novelty of the bagging assembly and method of use thereof, reference is hereafter made to the accompanying drawings. With reference now to FIG. 1, in a first simplified embodiment a bagging assembly 10 may include a base member 12 and an inlet member 14 operationally configured to mate with the base member 12 (see directional arrow A) in a manner effective to hold a bag or like item in an open position there between during operation of the bagging assembly 10. In this embodiment, the base member 12 suitably includes a first mating member 16 and a plurality of support members 18 (or “supports”) for maintaining the first mating member 16 apart from a support surface of the bagging assembly 10. As shown in FIG. 2, the first mating member 16 may be provided as an annular member having an outer surface 20 and an inner surface 22 defining an opening there through whereby the inner perimeter of the first mating member 16 at the inlet 24 is substantially similar as the inner perimeter of the first mating member 16 at the outlet end 26. As such, in at least one embodiment the first mating member 16 may include a ring like configuration although other shapes and sizes are herein contemplated.

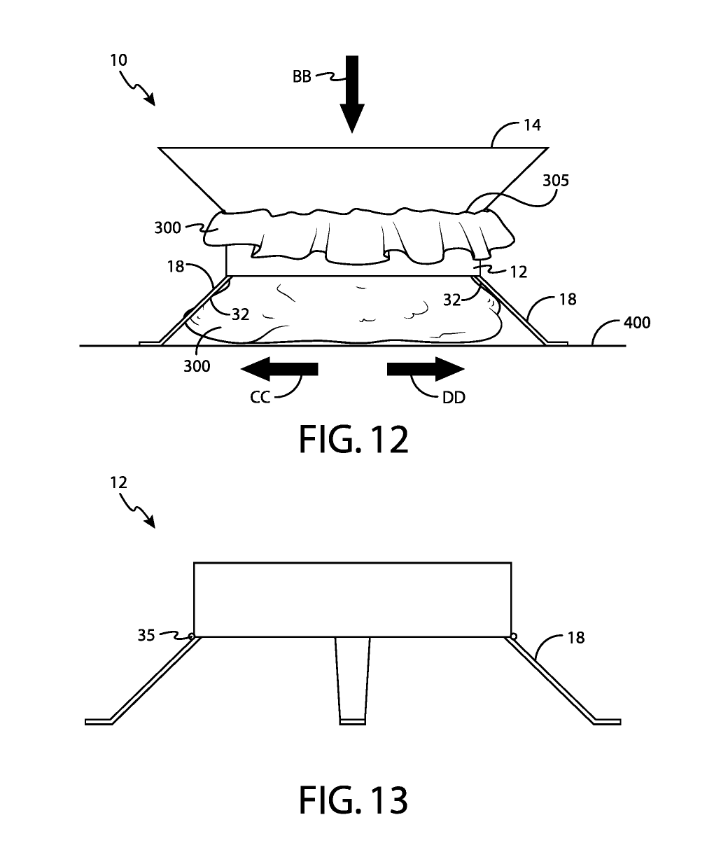

In the embodiment of FIG. 1, the inlet member 14 suitably has a conical inlet 15 and a mating stem member 27 (or “stem”) extending from the base 30 of the inlet member 14 a desired distance. As shown, the stem 27 may include a cylindrical or ring like configuration similar as the first mating member 16 described above with an inner diameter substantially similar as the inner diameter of the circular base 30 of the inlet member 14. As shown, the stem 27 suitably includes an outer surface 28 and an inner surface 31 (see FIG. 20) defining an opening there through whereby the stem 27 is effective as a male member for mating with the female opening of the first mating member 16. In one implementation, the stem 27 may include a height less than the height of the corresponding first mating member 16. In another implementation, the stem 27 may include a height about equal to the height of the corresponding first mating member 16. In another implementation, the stem 27 may extend beyond the outlet end 26 of the first mating member 16 a distance effective to facilitate the filling of a bag with one or more storables—as explained in more detailed below. As understood by the skilled artisan, the stem 27 may include an outer surface 28 operationally configured to substantially abut the inner surface 22 (see FIG. 2) of the first mating member 16. In operation, the stem 27 of the inlet member 14 suitably rests within the first mating member 16 via gravity as shown in FIG. 3. As shown, the inlet member 14 suitably sits atop the base member 12 in a manner effective to sandwich at least part of the perimeter of a bag 300 (see FIG. 12) or like item against the inner surface 22 of the first mating member 16 in a manner effective to cover, guard and protect a portion of the open bag 300 where an operator is using a tool, e.g., a rake, shovel, broom, or other hand held tool, to direct or force storables into the corresponding vertically set bag 300. At a minimum, the bottommost portion of the inlet member 14 at or near the base 30 suitably contacts the upper most edge of the first mating member 16 (see inlet 24) in a manner effective to sandwich at least the part of the perimeter of a bag 300 disposed there between to fix and maintain a bag 300 in an open position vertical position.

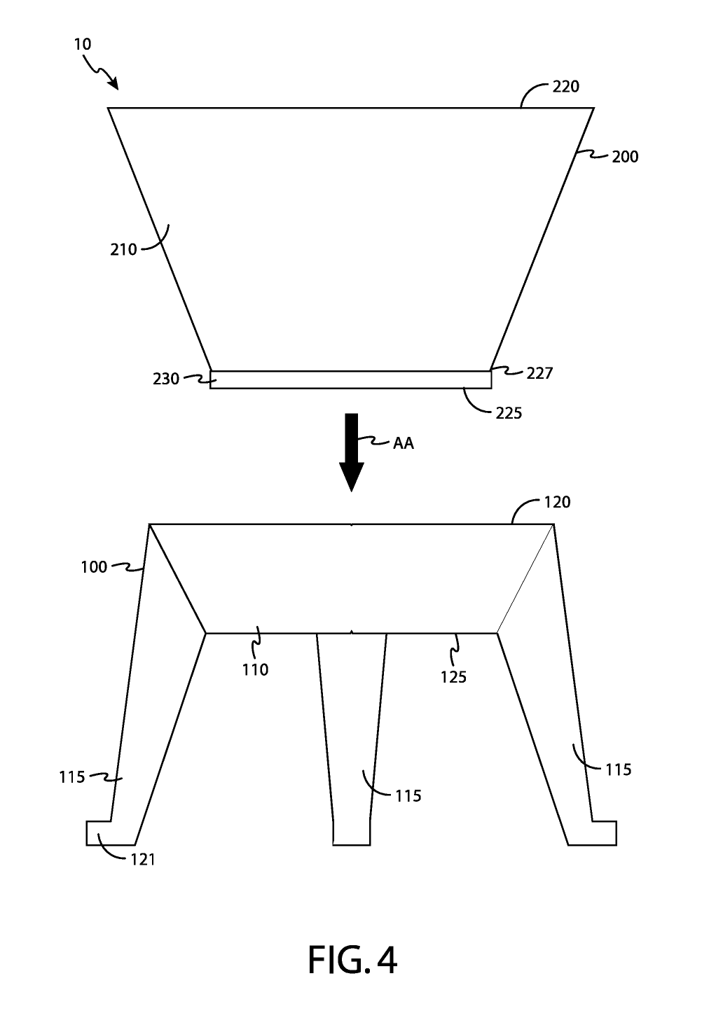

Turning to FIGS. 4-6, in another embodiment the bagging assembly 10 may include a base member 100 having a conical mating surface and an inlet member 200 having a corresponding conical mating surface that is operationally configured to substantially abut the inner surface of the base member 100 (see directional arrow AA) in a manner effective to hold a bag 300 or like item in an open position there between during operation. In this embodiment, the base member 100 includes a first mating member 110 and a plurality of supports 115 for maintaining the first mating member 110 apart from a support surface.

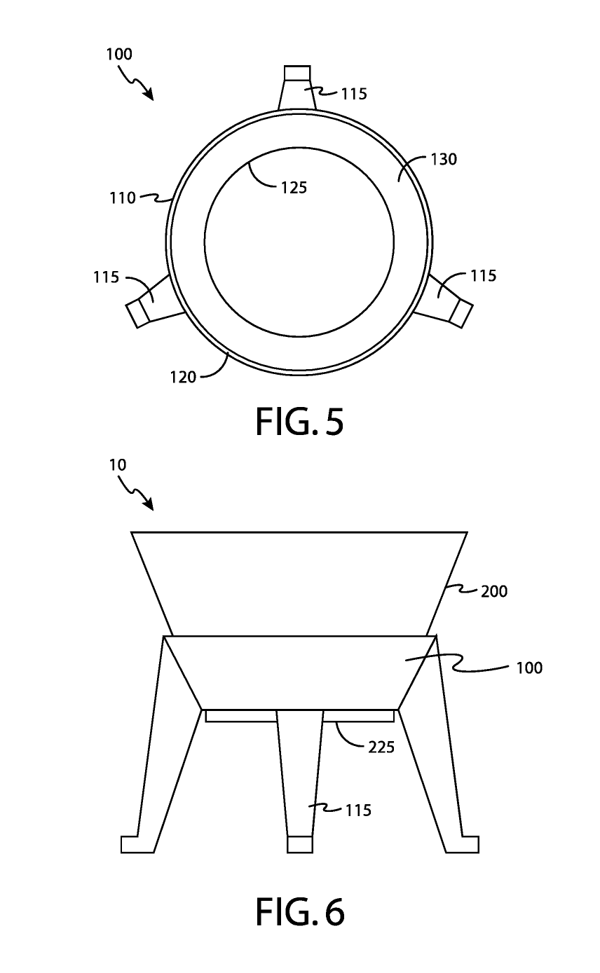

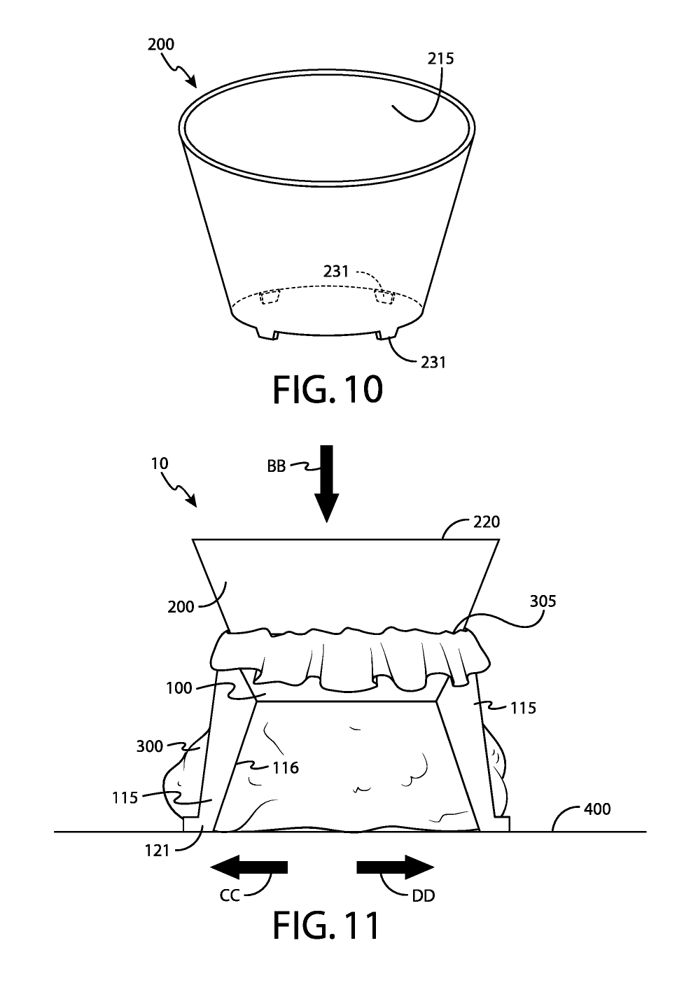

Referring to FIGS. 4 and 5, the first mating member 110 suitably includes a first inner mating surface 130 defined by an opening there through whereby the inner perimeter of the first mating member 110 at the inlet 120 is greater than the inner perimeter at the outlet 125 of the first mating member 110. In like manner, the inlet member 200 suitably includes a perimeter second mating outer surface 210 and an inner surface 215 (see example of FIG. 10) defined by an opening there through, the outer surface 210 corresponding to the first inner mating surface 130 allowing the outer surface 210 to substantially abut the first inner mating surface 130 during operation of the bagging assembly 10. As shown in FIG. 4, the inner perimeter of the inlet member 200 at the inlet 220 is greater than the inner perimeter at the outlet 225 of the inlet member 200.

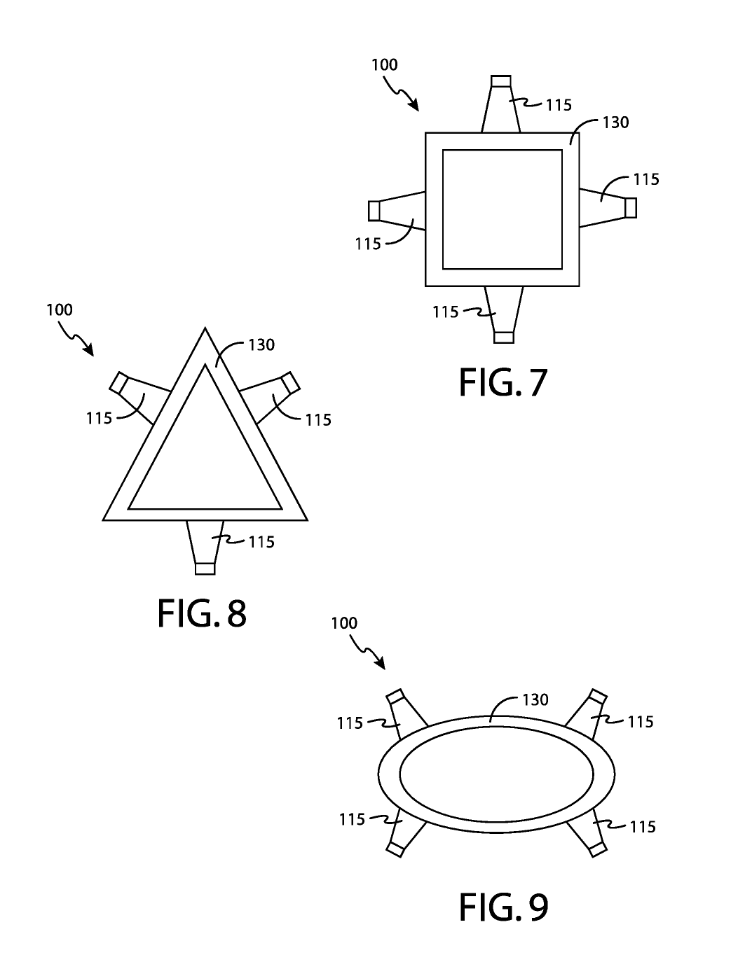

As shown, the first mating member 110 may include an annular member including a conical tapered inner mating surface 130 for receiving a corresponding concentric annular inlet member 200 having a conical tapered outer surface 210 for abutment with mating surface 130 (see FIG. 6). In operation, the inlet member 200 may rest within the first mating member 110 via gravity whereby the outlet 225 of the inlet member 200 extends beyond the outlet 125 of the first mating member 110. In other embodiments, the first mating member 110 and corresponding inlet member 200 may include multi-sided sloping configurations and oblong configurations as desired or as otherwise required—see for example the simplified embodiments of a base member 100 of FIGS. 7-9.

Referring again to FIG. 4, the outlet 225 of the inlet member 200 may also be defined by a stem 230 extending from the base 227 of the inlet member 200 that is operationally configured to extend beyond the outlet 125 of the first mating member 110 in a manner effective to facilitate the filling of a bag—as explained in more detailed below. In this embodiment, the stem 230 suitably includes an outer surface configuration corresponding to the inner perimeter of the outlet 125, e.g., a cylindrical inner perimeter of the outlet 125 and cylindrical outer surface of the stem 230. Likewise, the stem 230 suitably includes a shape substantially corresponding to the base 227 of the inlet member 200, e.g., a conical inlet member 200 suitably includes a cylindrical base 227 with a cylindrical stem 230 extending there from a desired length.

It is to be appreciated that in other embodiments of the bagging assembly 10 an inlet member (14, 200) may be devoid of a stem (27, 230) altogether or an inlet member (14, 200) may include one or more appendages or guides 231 operationally configured to extend beyond the outlet (26, 125) of the first mating member (16, 110) in a manner effective to facilitate the filling of a bag 300 (see the simplified example of guides 231 in FIG. 10). With particular attention to FIG. 10, the inner surface (22, 215) of an inlet member (14, 200) may include a continuous surface of 360.0 degrees. In another embodiment, the inlet member (14, 200) may include a cylindrical shape with a beginning and terminal ends less than 360.0 degrees. In addition, the inner surface (22, 215) of an inlet member (14, 200) may be substantially smooth. In another embodiment, the inner surface (22, 215) may include one or more raised surfaces as desired. In another embodiment, the inner surface (22, 215) may include one or more coatings or outer surface layers or coatings effective to promote passage of storables into a corresponding bag 300 along the inner surface (22, 215). For example, the inner surface (22, 215) may be provided with an outermost layer of one or more fluoropolymers including, but not necessarily limited to polytetrafluoroethylene (“PTFE”). In another embodiment, the inner surface (22, 215) may be provided with an outermost layer of polished metal. Similar as the embodiment of FIG. 1, the inlet member 200 shown in FIG. 4 suitably sits atop a bag 300 in a manner effective to cover, guard and protect the bag 300 where an operator is using a tool, e.g., a rake, shovel, broom, and other hand held tool, to force storables into the bag 300. An example of tool usage may include the need to use a tool to force leaves into a bag 300 if and when leaves gather or stick atop the inner surface 215 rather than fall naturally into the bag 300 via gravity.

Turning to FIG. 11, when the inlet member 200 is set to an operating position mated with the base member 100, the entire mating surface 130 of the first mating member 110 and at least part of the outer surface 210 of the inlet member 200 are operationally configured to sandwich an open end of a bag 300 or like item there between in a manner effective to maintain the bag 300 in an open position as one or more storables are directed into the bag 300 at the inlet 220 of the inlet member 200 (see directional arrow BB). As such, the weight of the inlet member 200 is effective to maintain a constant force upon the mating surface 130, and the bag 300 sandwiched there between, in a manner effective to hold the open end of the bag 300 sandwiched there between in a fixed position at a particular altitude above the support surface 400 during operation of the bagging assembly 10. In other words, the sandwiching effect of the inlet member 200 and the first mating member 110 is operable for applying a constant force 360.0 degrees about the perimeter of the open end of the bag 300. The same principle describes the operable configuration of the bagging assembly 10 of FIG. 1 (see for example FIG. 12) wherein the base member 12 and the inlet member 14 sandwich an open end of a bag 300 there between in a manner effective to maintain the bag 300 in an open position allowing one or more storables to be directed into the bag 300 at the inlet 15 (see directional arrow BB).

Although the bagging assembly 10 may be built to scale, in operation using a commercially available plastic yard bag 300, a suitable bagging assembly 10 is operationally configured to sandwich a percentage of the length of the bag 300 effective to restrict or otherwise minimize stretching and/or tearing of the bag 300 as the bag is weighted down by storables contained therein. One suitable bagging assembly 10 is operationally configured to sandwich up to about 34.0 percent of the length of a bag 300, e.g., a plastic bag, along its perimeter during operation.

As FIGS. 11 and 12 illustrate, the open end of the bag 300 may extend out beyond the first mating member (16, 110) to ensure maximum surface area sandwiching of the bag 300 between the base member (12, 100) and the inlet member (14, 200). As further shown, the supports (18, 115) suitably include a length effective for a closed end of a bag 300 to rest upon a support surface 400 as the bag 300 is being filled with one or more storables—thereby minimizing stretching or other physical stresses placed on the bag 300. Likewise, the supports (18, 115) are suitably provided in a number and oriented about the first mating member (16, 110) in a manner effective to restrict lateral bulging of the bag 300 (see directional arrows CC and DD) as the bag 300 is being filled with storables. In other words, the supports (18, 115) are operationally configured to minimize stress placed on the bag 300 and/or minimize pulling of the open end of the bag 300 down and out from between the sandwiching surfaces of the bagging assembly 10, e.g., (1) down and out from between the inner surface of the first mating member 16 and the outer surface of the stem 27 of FIGS. 1 and (2) down and out from between the mating surface 130 of the first mating member 110 and the outer surface 210 of the inlet member 200 of FIG. 4, as the bag 300 is filled with storables.

As shown in FIGS. 11 and 12, the supports (18, 115) may be provided as substantially straight leg type members. One or more supports (18, 115) may also include non-straight configurations as desired or otherwise required for a particular use. It is contemplated that the inner surface (32, 116) of one or more supports (18, 115) may include any shape as desired similar to the plurality of leg shapes seen in furniture items. For example, the supports (18, 115) may include inner surfaces (32, 116) effective to configure a bulging bag 300 in a particular form, e.g., curved inner surfaces for forming a rounded bag 300 of a particular form that makes it easy to tie off an open end of a bag 300 when the inlet member 14 or 200 is removed from the base member (12, 100).

The supports of this application may also include extensions or feet at or near the bottom of the supports—see for example the feet 121 at the bottom of supports 115 in FIG. 11. As shown, the feet 121 may extend outward beyond the perimeter of the outlet 125 whereby the perimeter formed by the supports 115 on the support surface 400 is greater than the perimeter of the opening of the first mating member (16, 110) of the embodiments discussed herein. In another embodiment, the perimeter formed by the supports (18, 115) on the support surface 400 may be less than the perimeter of the opening of the first mating member (16, 110). In still another embodiment, the surface area between the supports (18, 115) on the support surface 400 may be substantially equal or equal to the perimeter of the opening of the first mating member (16, 110).

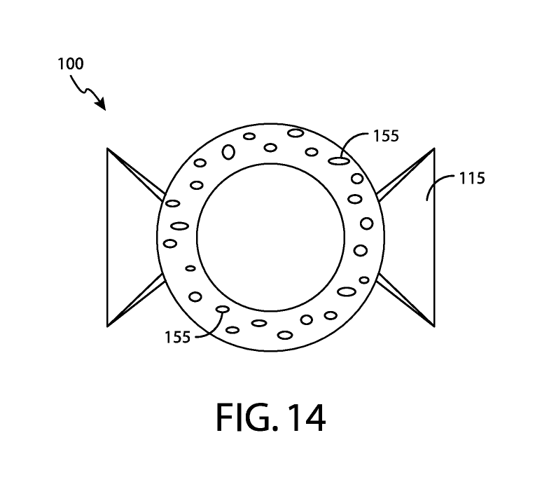

It is further contemplated that one or more of the supports (18, 115) may be (1) hingedly attached to the first mating member (16, 110)—see for example the hinge 35 in FIG. 13) and/or (2) releasably attached as understood by the skilled artisan via male/female fittings and/or latch type connections. In another embodiment, it is also contemplated that the base member 12 and inlet member 14 (or the base member 100 inlet member 200) may include one or more apertures 155, slits, or the like there through in a manner effective to minimize the total weight of the bagging assembly 10—see the simplified illustration of FIG. 14.

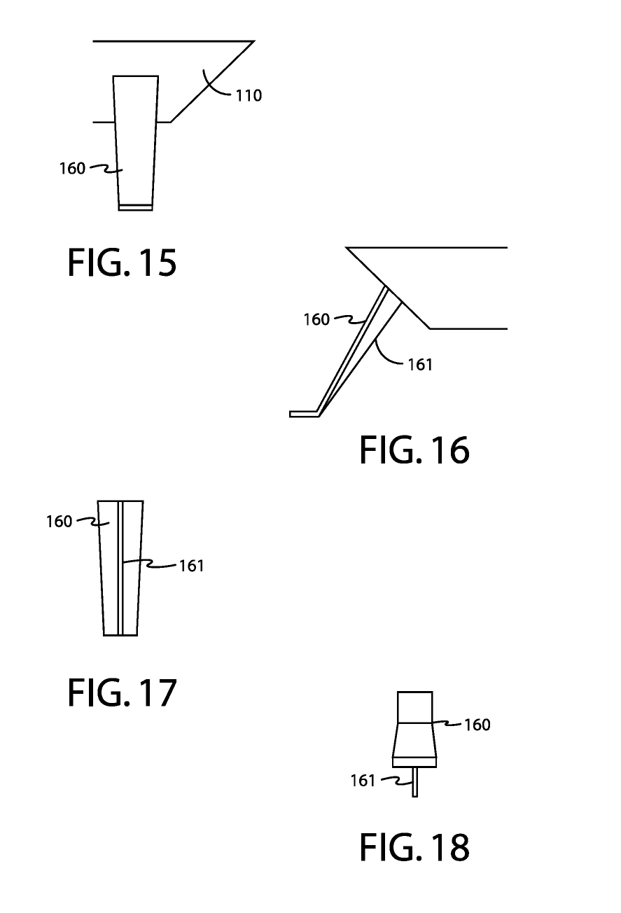

As further shown in FIG. 14, the supports 115 may be provided as widened members whereby two supports 115 are effective for maintaining the bagging assembly 10 in an upright position during operation. As shown in FIGS. 15-18, one particular support 115 configuration may include a one piece structure comprising a first planar member 160 and one or more rib members 161 disposed along the inner surface of the first planar member 160, the one or more rib members 161 adding structural strength to the support 115, i.e., the one or more rib members 161 are operationally configured to prevent the support 115 from bending or from excessive bending during bagging assembly 10 operation. As shown in FIG. 17, one suitable support 115 includes a single rib member 161 disposed along the length of the first planar member 160 at or near the centerline of first planar member 160. Without limiting the shape and/or size of the rib member 161, one suitable rib member 161 may extend out from the first planar member 160 a maximum distance at its point of attachment to the first mating surface 110 and taper inward terminating at the distal end of the first planar member as shown in FIG. 16, e.g., a triangular shape. As shown in FIG. 18, the first planar member 160 may include a shape varying from a single planar member by including two or more planar members.

In one embodiment, the base members (12, 100) and the inlet members (14, 200) described herein may be constructed from one or more like materials. In another embodiment, the base members (12, 100) and the inlet members (14, 200) may be constructed from one or more unlike materials. Suitably, the base member (12, 100) and the inlet member (14, 200) employed are constructed from one or more materials durable enough to operate for bagging operation as described herein. In particular, the base members (12, 100) and the inlet members (14, 200) may be constructed from materials including, but not necessarily limited to those materials resistant to chipping, cracking, excessive bending and reshaping as a result of ozone, weathering, heat, moisture, other outside mechanical and chemical influences, as well as various impacts and other loads placed on the bagging assembly 10. Likewise, the base members (12, 100) and the inlet members (14, 200) described herein may comprise any color or combination of colors, or in the alternative, the base members (12, 100) and/or the inlet members (14, 200) may be transparent and translucent.

Suitable materials of construction of the bagging assembly 10 may include, but are not necessarily limited to metals, plastics, rubbers, woods, fiberglass, plexiglass, filled composite materials, and combinations thereof. Suitable plastics include, but are not necessarily limited to vinyl polymers, polyvinyl chloride (PVC), polycarbonate, polyethylene, high density polyethylene, polyethylene terephthalate, polypropylene, polystyrene, polyvinyl chloride, and mixtures thereof. Suitable metals include, but are not necessarily limited to aluminum, steel, titanium, and combinations thereof Suitable woods include, but are not necessarily limited to softwoods, hardwoods, and combinations thereof as such terms and the varieties of woods of each are understood by persons of ordinary skill in the art. In addition, the base member (12, 100) and/or the inlet member (14, 200) employed may include one or more apertures there through and/or cut outs and/or slits in the body effective to lessen the overall weight of the bagging assembly 10, e.g., see FIG. 14. Engineered wood products may also be employed such as wood composite materials made of wood fibres, wood particles, wood veneer, wood strands or mixtures thereof Examples of engineered wood products included, but are not necessarily limited to plywood, laminated veneer lumber, oriented strand board, particle board, medium density fibre board, and combinations thereof.

With reference to the embodiment of FIG. 1, the base member 12 is suitably set on a support surface 400 in an upright position. A bag 300 is then inserted through the opening of the first mating member 16 and the open end of the bag 300 is contacted against or draped over the first mating member 16 whereby at least part of the open end 305 of the bag 300 extends outward over the outside of the first mating member 16. Once the bag 300 is set in place with the base member 12, the corresponding inlet member 14 may be placed or set atop the first mating member 16 sandwiching part of the bag 300 there between. Thereafter, one or more storables may be directed into the open bag 300 via the inlet 15. Once the bag 300 is filled with storables as desired, the inlet member 14 may be removed from the first mating member 16, the open end 305 of the bag 300 may be tied or otherwise closed off or sealed and the base member 12 may be lifted up apart from the bag 300 so that the bag 300 may be carried disposed of In another embodiment where a bag 300 is sufficiently under filled, once the bag 300 is tied or otherwise closed off or sealed the bag 300 may be lifted up through the first mating member 16 or pulled out from between two supports 18.

The invention will be better understood with reference to the following non-limiting example, which is illustrative only and not intended to limit the present invention to a particular embodiment.

### Example 1

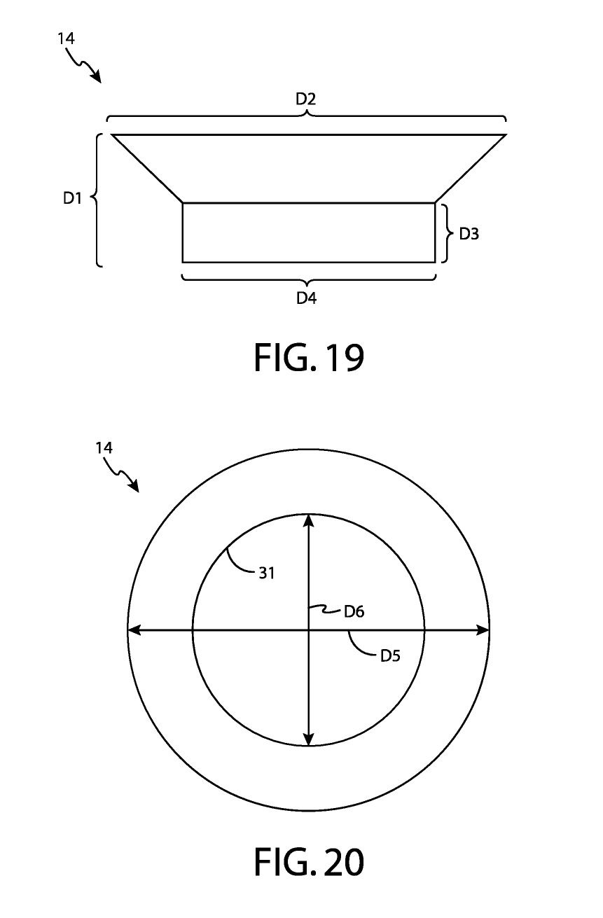

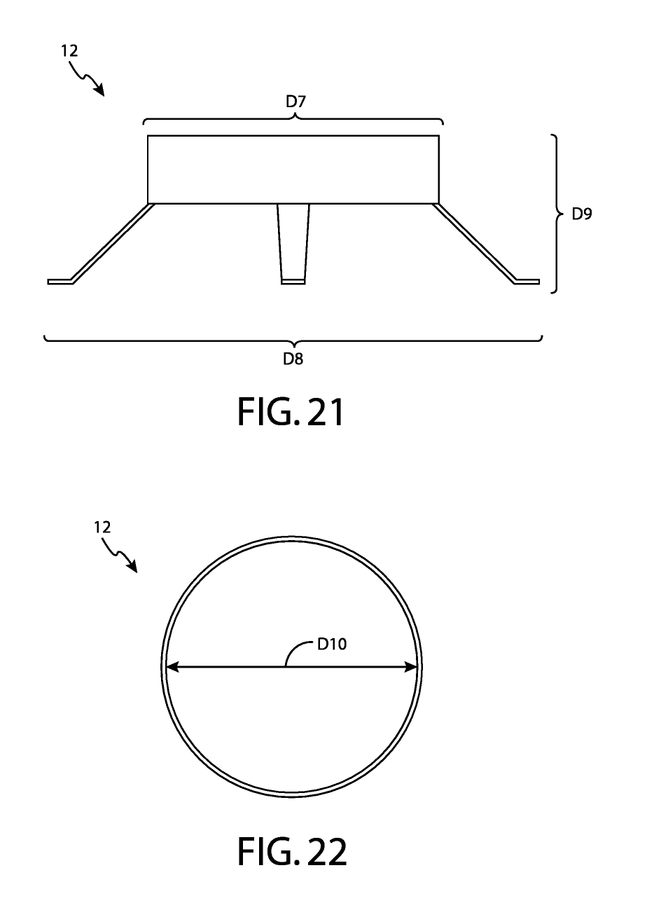

With reference to FIGS. 19-22, in a first non-limiting example, a bagging assembly 10 constructed from polypropylene and operationally configured for use with bags ranging in size from 113.6 liters to 170.3 liters (thirty gallon to forty-five gallon) is provided having the following dimensions:

D1: about 50.8 cm (about 20.0 inches)

D2: about 55.9 cm (about 22.0 inches)

D3: about 12.7 cm (about 5.0 inches)

D4: about 44.5 cm (about 17.5 inches)

D5: about 55.9 cm (about 22.0 inches)

D6: about 43.2 cm (about 17.0 inches)

D7: about 45.7 cm (about 18.0 inches)

D8: about 61.0 cm (about 24.0 inches)

D9: about 53.3 cm (about 21.0 inches)

D10: about 44.5 cm (about 17.5 inches)

The first mating member 16 of the base member 12, the inlet member 14 and the supports 18 each having a wall thickness of about 0.64 cm (about 0.25 inches) plus/minus (+/−) 0.32 cm (0.125 inches).

As used in this specification and the appended claims, the singular forms “a,” “an” and “the” include plural referents unless the context clearly dictates otherwise.

Persons of ordinary skill in the art will recognize that many modifications may be made to the present invention without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A bagging assembly, including:
a base member having a first mating member and a plurality of support members operationally configured to maintain the first mating member apart from a support surface of the bagging assembly, the first mating member having an inner surface defining an opening there through; and
an inlet member operationally configured to releasably mate with the base member in a manner effective to maintain an open end of a bag between the inner surface of the first mating member and the inlet member in an open position for directing storables into the bag via the inlet member.

2. The bagging assembly of claim 1 wherein the inlet member includes a conical inlet and a cylindrical stem extending from the inlet, the stem having an outer surface operationally configured to abut the inner surface of the first mating member.

3. The bagging assembly of claim 1 wherein the distance between the base member and the support surface of the bagging assembly is less than the length of the bag maintained between the inner surface of the first mating member and the inlet member.

4. The bagging assembly of claim 1 wherein the base of the support members is located beyond the outer diameter of the first mating member.

5. A bagging assembly for holding a bag in an open position, including:
a base member including a cylindrical first mating member and a plurality of support members operationally configured to maintain the first mating member apart from a support surface of the bagging assembly; and
an inlet member having a conical shape member forming an inlet end and a cylindrical shape member forming an outlet end of the inlet member, the cylindrical shape member being operationally configured to releasably mate with the first mating member, the outer diameter of the cylindrical shape member being less than the inner diameter of the first mating member.

6. The bagging assembly of claim 5 wherein the outer diameter of the conical shape member at its inlet end is greater than the height of the bagging assembly.

7. The bagging assembly of claim 5 wherein the bagging assembly is operationally configured to sandwich up to about 34.0 percent of the length of a bag there between.

8. A method of maintaining a bag in an open position for filling purposes, including:
providing a bagging assembly including (1) a base member having a first mating member and a plurality of support members operationally configured to maintain the first mating member apart from a support surface of the bagging assembly, the first mating member having an inner surface defining an opening there through; and (2) an inlet member operationally configured to releasably mate with the base member in a manner effective to maintain an open end of a bag between the inner surface of the first mating member and the inlet member in an open position for directing storables into the bag via the inlet member;
placing the base member upon a support surface in an upright position;
inserting a bag through the opening of the first mating member and contacting an open end of the bag against the inner surface of the first mating member; and
placing the inlet member atop the base member in a manner effective to sandwich the bag there between.
